(19) United States
(12) Patent Application Publication
(10) Pub. No.: US 2009/0077539 A1
(43) Pub. Date: Mar. 19, 2009

(54) System and method for endpoint device testing

(75) Inventor: Mark Fred Booth, Kenniewick, WA (US)

Correspondence Address: MITEL NETWORKS CORPORATION;MICHELLE WHITTINGTON, ESQ., 7300 WEST BOSTON STREET, CHANDLER, AZ, 85226, US

(73) Assignee: INTER-TEL (DELAWARE), INC.

(21) Appl. No.: 11/901,092

(22) Filed: Sep. 14, 2007

(51) Int. Cl. G06F 9/44

(52) U.S. Cl. 717/124

(57) ABSTRACT

A telecommunications system testing arrangement is disclosed that verifies the operation of a large distributed system of endpoints. This test system simulates actual real-time user actions on a live system that is under test. The disclosed system may improve the testing process by (1) using the actual endpoints themselves to generate traffic/actions, and (2) monitoring the system response. The disclosed system may also be configured to automatically encode test scripts based on user actions on a endpoint device, and/or to convert specific information into variables. These variables may facilitate cross platform use of the test script.

### COPYRIGHT NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD OF INVENTION

The present invention relates generally to testing the performance of customer-owned networks of communications systems, and/or to testing the performance of endpoint devices in such systems.

### BACKGROUND OF THE INVENTION

Testing of communications systems facilitates improved performance of such systems. For example, telephonic communications systems may include many endpoint devices (e.g., telephones). Often times, upon installation of such telephonic communication systems, or when software or hardware are changed, it is desirable to test the system. It may also be desirable to test the system to make sure that previously working portions of the system are still working. In many instances, manual testing is the method used to determine if the communications system is working as desired. In manual testing, a human may make calls from an endpoint device and experiment with other functions the endpoint may offer. Unfortunately, manual testing is time consuming, prone to inaccuracy and lack of repeatability, and is generally not a method that can be employed to obtain comprehensive results.

Many automated methods have been used to test communications systems. However, these methods often only emulate the activities of the endpoint devices and fail to actually test the endpoint devices. Moreover, existing automated testing often still requires human testing personnel to manually use the endpoint devices. Also, existing automated testing is typically not sufficient to test the instantaneous response of actual endpoint devices. Thus, there is a need for new systems, methods and devices for automated testing of communications systems having endpoint devices.

### SUMMARY OF THE INVENTION

Example methods for facilitating testing of a large number of distributed endpoints in a telecommunications system are disclosed. One of these exemplary methods comprises the step of identifying, with unique extension identifiers, the extensions of the distributed endpoints that are to be tested; creating a script, wherein the script includes at least some of the unique extension identifiers, wherein the script is created at least in part by recording actions taken on one or more endpoint devices, wherein each action taken generates a portion of the script. The method further comprises the steps of automatically converting specific portions of the script into variables; saving the script; executing the script; and reporting the results of running the script.

Example phone testing engines, configured for testing a large number of distributed endpoints in a telecommunications system, are also disclosed. An exemplary phone testing engine may comprise a script creating module; wherein the script creating module is configured to create a script based at least in part on recordation of actions taken on an endpoint device, wherein the script creating module is further configured to save the script, wherein the script creating module is further configured to identify specific portions of the script and to substitute variables for the specific portions of the script, such that the script can be played back on different systems seamlessly. The exemplary phone testing engine may also comprise a script playing module; wherein the script playing module is configured to play the script on designated endpoints of the large number of distributed endpoints.

### BRIEF DESCRIPTION OF THE DRAWINGS

A more complete understanding of the present invention may be derived by referring to the detailed description and claims when considered in connection with the Figures, wherein like reference numbers refer to similar elements throughout the Figures, and:

FIG. 1 is a block diagram illustrating an exemplary system suitable for endpoint testing in accordance with the various embodiments;

FIG. 2 is a flow chart for creating and executing test scripts in accordance with various embodiments of the present invention;

FIG. 3 is a screenshot of a primary endpoint device testing interface in accordance with an exemplary embodiment of the present invention;

FIG. 4 is a screenshot of a script editing interface in accordance with an exemplary embodiment of the present invention;

FIG. 5 is a screenshot of an action step configuration interface in accordance with an exemplary embodiment of the present invention;

FIG. 6 is a screenshot of an action step selection interface in accordance with an exemplary embodiment of the present invention;

FIG. 7 is a screenshot of an action step recording interface in accordance with an exemplary embodiment of the present invention;

FIG. 8 is a screenshot of a endpoint testing log viewer interface in accordance with an exemplary embodiment of the present invention; and,

FIG. 9 is a screenshot of endpoint testing reporting interface in accordance with an exemplary embodiment of the present invention.

### DETAILED DESCRIPTION

The detailed description of exemplary embodiments of the invention herein makes reference to the accompanying drawings, which show exemplary embodiments by way of illustration and best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

In general, in accordance with various embodiments of the present invention systems and methods are provided for facilitating performance testing and load testing of a system of endpoint devices within a network. For example, the system may invoke a preconfigured script configured for testing transfers among any number of endpoint devices on a network. The system may then enable the user (e.g., tester) to interact with the system by way of a personal computer, workstation, server, and the like to select test scripts, configure test scripts, select endpoint devices, execute endpoint testing, and view testing reports. Test scripts, as used herein, provide a testing engine with a number of tests that are performed at each endpoint device including, but not limited to, placing calls, receiving calls, placing calls on hold, transferring calls, putting calls through to voicemail, and the like.

More specifically, in accordance with an exemplary embodiment, the user may select a preconfigured script and apply it to various endpoint networks with little or no modification and without foreknowledge of the extensions of the endpoint devices to be tested. Accordingly, in this example, the testing engine is configured to interface with a control server (e.g., call processing server) on an endpoint device network to retrieve extensions for all, or a subset of, endpoint devices on a network.

Thus, systems and methods for performing a test of a system of networked endpoint devices is disclosed herein. The system disclosed may comprise an application that interfaces with a variety of endpoint devices and provides a simple, user-friendly, Graphical User Interface (GUI) to develop a set of test scripts that verify proper functionality of endpoint devices in conjunction with the system applications that control them. The system facilitates the set up of the test scripts to be run in the endpoints and control server and also to designate which endpoints will take part in the test. The setup of the test is accomplished by directly controlling the endpoints to appear in the main test control scripts as function calls from the main test scripting software.

The system and methods enable live users at the endpoints to manually enter test steps for recording. The main test server notices the events created by the manual user entries and records them as a reusable script to run and edit at a later time. Scripts may be run on endpoints as groups so as to increase the load on the system under test using test sequences that pass live communications links directly between the endpoints to test features such as call transfer, call holding, and forwarding features. This allows call sequences within groups to be expanded quickly by adding more groups to the test in an increasing load scenario.

Software objects may be used to group control of endpoints connected to the network using a peer-to-peer distributed architecture. Each endpoint is a participative object that is automatically tied into a common set of test code that has inherent control to functions within the endpoints that behave just as if someone is physically manipulating the controls and functions equipped on the endpoint devices.

In accordance with various aspects of the present invention, the testing engine establishes a direct connection with each endpoint device under test without passing through a control server for the network. In this manner, the testing engine is able to pass codes directly to the endpoint device's internal processor. As such, the testing engine is able to invoke the endpoint devices themselves to process calls according to a number of testing scenarios as dictated by the testing script. Thus, in accordance with various aspects of the present invention, systems and methods are configured to provide reliable and efficient testing of endpoint devices.

It is also notable to mention that the systems and methods of the endpoint device testing of the invention is completely portable for use in other communications systems. In other words, the generated testing scripts may be used over and over again in a variety of different types of unrelated systems.

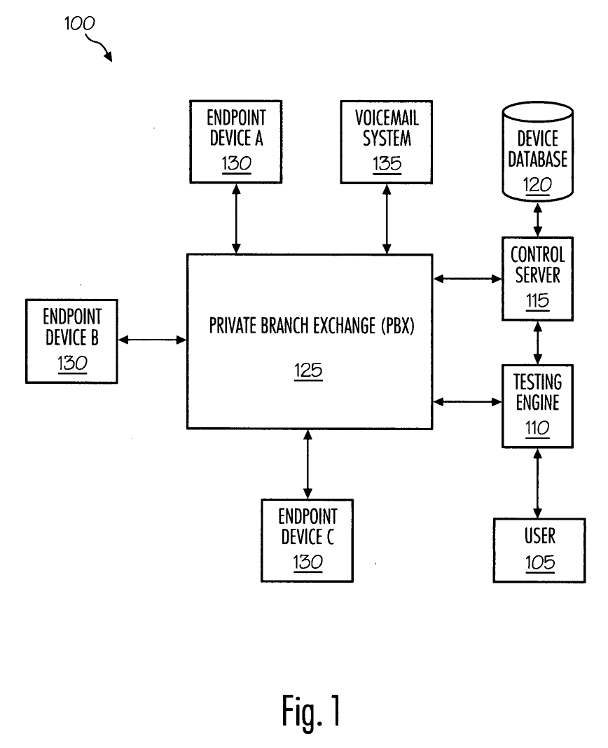

With reference to FIG. 1, and in accordance with various exemplary embodiments of the present invention, the system includes software, hardware, and/or data components that together comprise an Endpoint Testing System (ETS) 100. In accordance with an exemplary embodiment, ETS system 100 comprises at least one endpoint device 130 (e.g., telephone). ETS system 100 further comprises a testing engine 110, a control server 115, device database 120, a Private Branch Exchange (PBX) 125, and a voicemail system 135. A user 105 may interact with testing engine 110 to configure test scripts, invoke testing, and perform analysis relating to endpoint device 130 performance as will be described in greater detail herein.

User 105 may be any person with access to ETS 100. For example, user 105 may interact with a testing engine 110 in order to create new test scripts, modify existing test scripts, execute a test script, and view reports specifying the outcome of one or more tests. In an exemplary embodiment, user 105 is an endpoint installer, engineer, tester, and/or the like. User 105 may be, for example, a telephone technician who is responsible for designing, installing, and/or maintaining a complex telephone network within a corporation's home office.

In accordance with an exemplary embodiment of the present invention, test engine 110 is configured to interact with control server 115 and any number of endpoint devices. Testing engine 110 may establish a connection with control server 115 to retrieve one or more extensions corresponding to endpoint devices 130 to be tested. In an exemplary embodiment, testing engine 110 is configured to communicate with endpoint devices 130 that are under test. Testing engine 110 is configured to execute a test script to transmit codes representing any number of functions to endpoint devices 130, monitor results, and configure the results within one or more reports for analysis by user 105.

In one exemplary embodiment, control server 115 comprises any hardware and/or software suitably configured to control PBX 125, route calls to endpoint devices 130, and/or provide functionality typical in endpoint communication systems. Control server 115 may be a call processing server for the communication system. The PBX is configured as a realistic installable configuration and is setup in a manner that would be typical of an actual customer site. As call traffic is offered to the PBX, it is actually the PBX's overall response to the traffic that is being tested. The resulting events noted at the endpoints are used to analyze the performance of the PBX or other type of switching system being evaluated as part of the test. As various testing scripts are applied to the endpoints, the tests and corresponding results become elements of an overall battery of tests that are used to test many aspects of system behavior with the desired result to be to verify the absence of errors.

In one exemplary embodiment, PBX 125 may comprise any hardware and/or software suitably configured to interconnect endpoint devices 130. It should be understood that the term PBX is used quite loosely to refer to any in house or outsourced telephony switching system. In one exemplary embodiment, PBX 125 is a private voice-communications-capable switching facility which provides connection between endpoint devices connected to it, including dial service, and may provide connections between those endpoint devices and other communications networks, including the Public Switch Telephone Network (PSTN). PBX 125 may further include, or be interconnected with, a voicemail system 145 and a control server 115.

PBX 125 may comprise a communications switching structure based on Pulse Code Modulation (PCM), Internet Protocols (IP), Asynchronous Transfer Mode (ATM), or any other call processing-controlled switching arrangement that serve the needs of customers with real-time and messaging communications features. PBX 125 and some of its associated components may be similar to systems utilized by businesses that use networked systems to fully respond to the constantly varying status and availability of system users who utilize endpoint devices to process real-time communications.

In one embodiment, endpoint device 130 may comprise any hardware and/or software suitably configured to facilitate communications between two or more parties and/or devices. Endpoint device 130 may take the form of a standard office phone, a menu-driven display phone, an IP-based phone, a soft-phone, and the like. In an exemplary embodiment, endpoint device 130 is a menu-driven display phone that is equipped with a display device including, for example, a graphical user interface (GUI). Endpoint device 130 may include physical keys that enable callers to place calls to specific telephone numbers and/or interact with the various other elements of ETS 100. In another embodiment, such physical keys may be enhanced and/or replaced by soft keys, which are incorporated within a GUI of a display device. In an exemplary embodiment, endpoint device 130 is configured to communicate with PBX 125 to provide telecommunications features such as those now know in the art.

In one exemplary embodiment, voicemail system 135 comprises any hardware and/or software suitably configured to receive incoming calls and record voice messages from callers for later playback by the intended call recipient. Practitioners will appreciate that a variety of voicemail systems are commercially available and that such systems may reside within an existing PBX 125 system or as a standalone server in the form of a computing device. In some embodiments, voicemail system 135 stores analog audio. In other exemplary embodiments, voicemail system 135 is configured to convert analog audio from a caller's voice into digitized data that can be stored on a computer hard drive. Voicemail system 135 may be invoked, for example, when testing engine 110 issues a command to transfer a call from an endpoint device 130 to voicemail system 135.

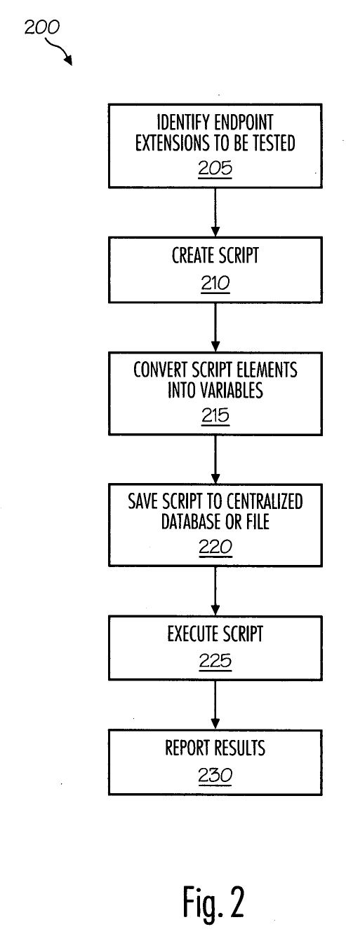

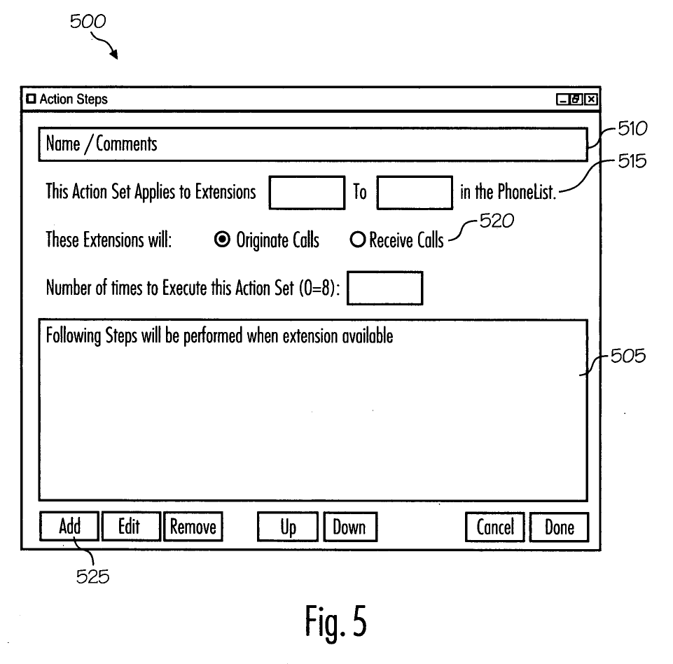

Referring now to FIG. 2, the process flow depicted is merely one embodiment of the invention and is not intended to limit the scope of the invention as described herein. For example, the steps recited in any of the method or process descriptions may be executed in any order and are not limited to the order presented. It will be appreciated that the following description may make appropriate references not only to the steps depicted in FIG. 2, but also to the various system components as described above with reference to FIG. 1 and call screening interface components described herein in reference to FIGS. 4-9. In one embodiment, ETS 100 includes a personal computer with a testing interface configured to enable user 105 to interact with ETS 100. Such an interface may include windows, web pages, websites, web forms, prompts, etc. It should be further appreciated that the multiple steps as illustrated and described may be combined onto single windows and/or web pages but have been expanded for the sake of simplicity. In other cases, steps illustrated and described as single process steps may be broken down into multiple windows and/or web pages but have been combined for simplicity.

There are a number of methods for displaying/presenting data within a testing interface of a personal computer. For example, relevant data may be represented as standard text or within a fixed list, scrollable list, drop-down list, editable text field, fixed text field, pop-up window, graphical representations, and the like. Likewise, there are a number of methods available for modifying data in a web page such as, for example, free text entry using a keyboard, selection of menu items, check boxes, option boxes, and the like.

In the description for FIG. 2, common reference is made to the process steps of transacting data transmissions between user 105, testing engine 110 and the various other components of ETS 100. However, practitioners will appreciate that the steps as described below may be accomplished through any number of process steps and methods producing similar results. As used herein, “transmit” may include sending electronic data from one system component to another over a network connection. Additionally, as used herein, “data” may include encompassing information such as commands, queries, files, data for storage, and the like in digital or any other form.

With reference to FIG. 2, the processes for performing endpoint testing in accordance with an embodiment of the present invention are described at a high level. More specific descriptions for carrying out the disclosed steps will be described in reference to the various screenshots that are illustrated in FIGS. 4-9.

In accordance with one exemplary method 200, user 105 interacts with testing engine 110 to identify the endpoint devices to be tested (step 205). For example, user 105 may identify five endpoint extensions. In accordance with another embodiment, the identified endpoint extensions may be generically identified. For example, the endpoint extensions to be tested may be identified as five random extensions, the first five extensions in a directory (numerically or alphabetically), and/or the like. In another embodiment, even when specific extensions are created, testing engine 110 is configured to genericize the extensions. Thus, a generic script can be created that can be used on specific communications system that are different from each other. In this example, the generic extension identification may be converted into specific extensions applicable to a specific communications system. For example, at the time of testing, testing engine 110 may be configured to communicate with control server 115 to request unique extension numbers for the endpoint devices to be tested, thereby eliminating the need to modify a test script between testing environments. Although described above in the context of converting specific extensions in a script into variables (generic extensions), other specific portions of the test scripts may be converted into variables. For example, test scripts may be renamed to make it easy to call them in sequence as part of successive testing suites. Each test suite may then be referred to with sequential names such as TEST1, TEST2, TEST3, etc. where each test contains an entirely new configuration of items such as extension numbers, user names, phone numbers, or port addresses. Then, when the next test suite in sequence is launched, the system may be entirely reconfigured and then arranged to run the new testing suite. The results of running each testing suite is reported in conjunction with each named test to make failure analysis less complex.

A test script is created (step 210), for example, by determining what functions on endpoint devices 130 should be tested, configuring wait and hold times, and identifying the order in which to execute the various functions to be tested. According to an exemplary embodiment, system 100 is configured so that a user 105 is not required to have knowledge of how to program in the test script language. Rather, the test script is generated by testing engine 110 in accordance with a number of selected test functions and variables. Furthermore, in an exemplary embodiment, when generating the test script, testing engine 110 is configured to convert selected portions of the test scripts into variables (step 215). Thus, in one exemplary embodiment, the created test scripts comprise instructions and those instructions may include variables. The test script may also include the values for those variables, or the test script may be configured to obtain those values (for example, via user input, or by requesting the values from the system to be tested). Testing engine 110 may further be configured to save the generated test script to a database and/or data file (step 220). The stored test script may be recalled and executed immediately following creation or at a later date.

Now with reference to testing a particular communication system, user 105 may interact with testing engine 110 to select one or more test scripts to run. Testing engine 110 retrieves the appropriate test scripts and executes them (step 225). Executing the test scripts may involve reading the instructions and variable values in the test script. Executing the test scripts may further involve establishing simultaneous or sequential connections with identified endpoint devices 130 to begin transmitting commands. When testing is complete, or while testing is in progress, testing engine 110 may gather information/results pertaining to the one or more tests and compile a report of the results for review (step 230).

The above described process steps may be carried out through an object oriented architecture in a manner that enables the resulting program to connect to multiple endpoints and actively run scripts on these endpoints concurrently. This is achieved by creating an object representing each endpoint including specific characteristics relating to each (e.g., display information, button status, audio paths, etc). In addition to modeling the status of endpoint devices, the individual endpoint objects also model their own IP address, username, and extension.

In accordance with one embodiment, testing engine 110 is segregated into several modules performing various functionalities, as are logically appropriate. Testing engine 110 may be composed of two modules for each phone type it supports (e.g., support for various versions of firmware running on various types of telephone endpoint devices). In an exemplary embodiment, testing engine 110 may comprise a module for recording scripts and a module for playing the scripts back. In another embodiment, a first module may model special commands unique to the supported endpoint for recording purposes (i.e., unique commands received for button presses, display changes, etc.), and a second module for playback of the scripts. There may further be any number of modules to operate the GUI aspects of the application as well as test script and log management.

When a set of scripts is launched, they may be run sequentially. The first script is evaluated and executed, and then the second script is evaluated and executed until all selected scripts have been executed. When testing engine 110 evaluates each individual script, the script is first validated and then parsed. A master “management” thread is spawned, which manages all of the endpoint threads and script execution/assignment. The master management thread further maintains all logging results for each endpoint 130. This thread instantiates all subsequent endpoint objects (and any corresponding threads) and maintains record of the completion status of the same. When an endpoint device 130 completes its assigned actions, it notifies the management thread that all actions are complete. Finally, when the management thread detects that all endpoint devices have completed their assigned actions, the next selected script is instantiated.

It should be appreciated that an action or script may be set to play continuously in order to verify continuous robustness of the system. The action or script may be running for a predetermined amount of time or until the user terminated it.

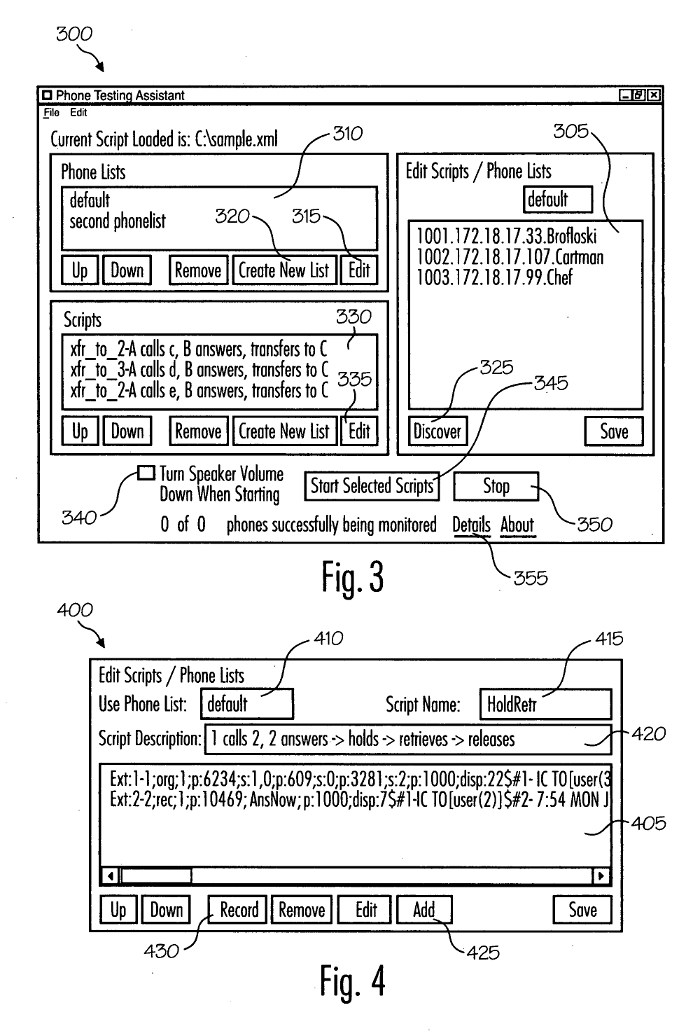

With reference to FIG. 3, testing engine 110 may provide a primary interface by which user 105 may interact to perform the above steps. When the testing engine 110 application is launched, the primary interface 300 is loaded, which may include three inter-related data entry areas. By default, the primary interface 300 starts up without loading scripts and/or endpoint lists. In another embodiment, testing engine 110 may load all, or a subset of, preconfigured testing scripts and/or endpoint lists. In one exemplary embodiment, the primary interface 300 enables user 105 to open a saved script set, or create a new script set from scratch.

In accordance with one embodiment, a script set may comprise any number of test scripts and endpoint lists. Script sets generally include a set of test scripts, which are configured to accomplish one or more specific goals. For example, a user may have an entire script set committed to testing call transfers among a number of endpoint devices. This set may have up to, for example, 100 different types of transfer scripts contained within it. Alternatively, a system installer may create a script configured for testing a wide range of features in order to conduct a basic functionality check of the system to verify proper installation.

According to one embodiment, a working script set is the currently active script set comprising one or more endpoint device lists and test scripts. The entire script set may be maintained in memory in order to speed the retrieval and editing of a script set. Moreover, the script set may be presented in a graphical manner as will be described herein, thereby providing convenient viewing and editing.

An endpoint list 305 specifies the list of extensions that a given test script will utilize during test. The list of available phone lists 310 may be sorted by selecting an item from the list and selecting either the up or down buttons located beneath the scripts list box 330. Data pertaining to a number of endpoint devices may be loaded to the endpoint list 305 by selecting an entry from the list of available phone lists 310, and selecting an edit button 315 or any other means of selection. If an endpoint list 305 or test script is already opened in the edit pane, testing engine 110 may prompt user 105 to save the existing endpoint list prior to loading a new endpoint list 305. An endpoint list 305 is specified during the creation of a test script, thus it may be advantageous to create an endpoint list 305 prior to creating a subsequent test script that will reference the endpoint list 305.

As illustrated, the endpoint list 305 values are Comma Separated Values (CSV) and include Extension, IP address, and Username. Practitioners will appreciate that any known convention for separating data values may be used (e.g., space, tab, character, etc.). Furthermore, any suitable endpoint identifiers may be used. In one embodiment, the username field may be optional. However, it may be advantageous to include the username field to be entered in order to enable a user to add variables representing a specific endpoint username in test scripts, as will be discussed in greater detail herein.

User 105 may construct a new list by, for example, selecting a “Create New List” button 320 on the primary interface 300. In response, testing engine 110 compiles a new list and populates the endpoint list 305 accordingly. A default name may be applied to the list (e.g., “new”, “default”, etc.) until such time that it is saved. User 105 may select a copy and paste function to go over values in the CSV or like format into the text box, or elect to “Discover” endpoints 325. Discover 325 causes testing engine 110 to establish a connection with a specified phone system by way of Secure Sockets Layer (SSL), for example, and retrieve a list of all registered endpoints on a specified network tenant. For example, testing engine 110 may communicate with control server 115 to discover the identities of the endpoints, or a subset thereof, on that system. Testing engine 110 formats the retrieved list of endpoint devices appropriately for proper display within the endpoint list 305 and appends the list of devices to the end of the endpoint list 305. Other similar methods of populating the endpoint list may also be used.

In accordance with one embodiment, user 105 may import an endpoint list from an existing XML or flat CSV file by selecting an appropriate menu option or corresponding button (not shown). The imported endpoint list 305 can be saved within any known or new file format such as, for example, a standard PTA (*.pta), or a comma delimited flat text file. When the endpoint list is imported, testing engine 110 adds the endpoints to the list of endpoint lists 305. In the case of an XML import, the testing engine 110 uses the name specified within the XML as the file name. Otherwise, if the import is a flat file, the endpoint list may be named to “Phonelistx”, for example, where x is the index of that list. System 100 may be configured to import files as describe herein or using any other method of importing files that is suitable for importing an endpoint list.

As noted above, a test script specifies the actual action steps that an endpoint will perform, including checks (e.g., display and audio) in order to pass or fail a given script. In one embodiment, the script list 330 displays the script name concatenated with the script definition. This may better provide a convenient preview of the general nature of the script prior to when it is formally loaded or selected for testing. The script list 330 includes a number of available scripts 330, which may be sorted by selecting an item and selecting a corresponding “up” or “down” button located in close proximity with the respective list box 330. If user 105 wishes to view and/or edit a script, user 105 may select the script from the script list 330 and click a corresponding “edit” button 335. If an endpoint list 305 or test script 330 is open in the edit pane, user 105 may be prompted to save the endpoint list 305 or test script 330 prior to loading a new script.

An example of a script editing interface 400 displays the action sets 405, name 415, description 420, and endpoint list 410 that are applicable to a selected test script. An action set 405 is a series of actions that an endpoint 130 is to execute a specified number of times. User 105 may create a script by essentially constructing a number of action sets. In one embodiment, one action set corresponds to each unique action path that the endpoints are to perform. For example, if endpoint A 130 calls endpoint B 130, and endpoint B 130 subsequently answers the call and then releases, the script may have two action sets; one for endpoint A 130 to dial endpoint B 130, and one for endpoint B 130 to answer the call and then release. If user 105 adds a transfer, then user 105 might add another action set for the actions of the third endpoint. In one embodiment, user 105 may select an “add” 425 or “record” 430 button.

In accordance with one embodiment, user 105 may manually construct a test script. By selecting an “add” button 425, for example, testing engine 110 may present user 105 with an action steps interface 500. Action steps interface 500 lists the steps 505 that are included in a given action set. In one embodiment, the action steps interface is not populated when constructing a new action set, however when editing an existing action, the action steps interface is populated with information corresponding to the existing action set. Prior to adding action steps, user 105 may be prompted to enter a name 510 to identify the action steps, extensions to which the action steps apply 515, whether the action sets are to invoke or receive calls 520, and how many times the action sets should be executed. To create the individual steps for an action set, user 105 may select an “add” button 525.

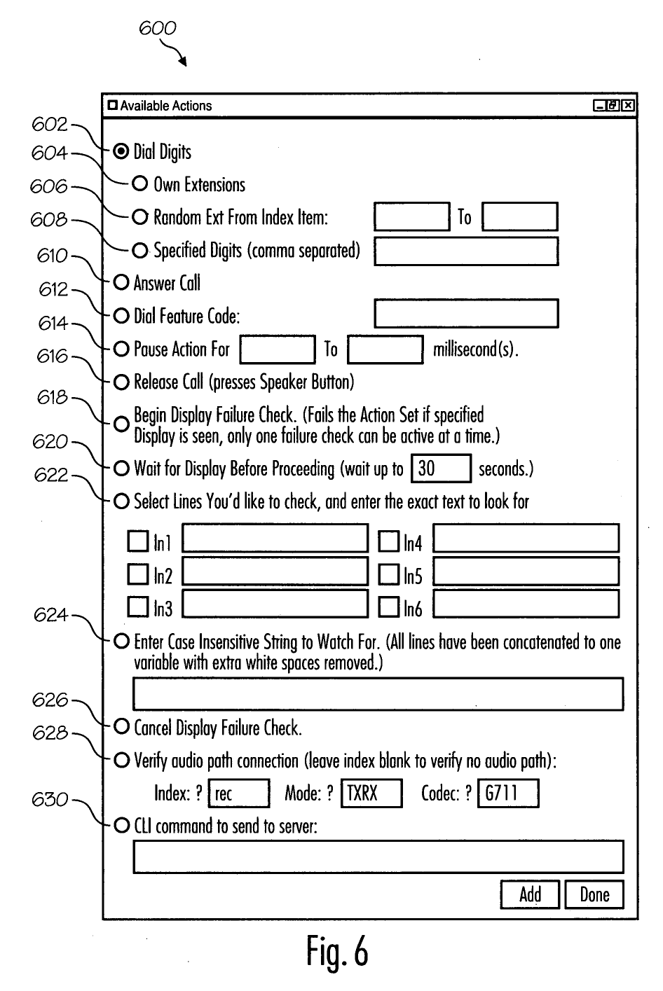

With reference to FIG. 6, an interface is provided that enables user 105 to select preconfigured steps to add to an action set. The available actions interface 600 provides an efficient means for configuring the steps that are performed in the execution of a test script. Such steps may comprise the following:
Dial Digits 602: This button may ask user 105 to further qualify what digits user 105 wishes testing engine 110 to dial and, for example, enables the three items below it (i.e., own extension, random extension from index item, and specified digits).
Own Extension 604: Dials the digits associated with its extension. This is particularly useful for identifying itself for load testing.
Random Ext. 606: Dials a random extension between the specified index items For example, 1-3 would pick any one extension between the first and third (inclusive) items on the phone list.
Specified Digits 608: Enables user 105 to specify any keystroke on the phone. (e.g., softkeys, feature keys, hook flash, volume keys, speaker key, DTMF/digit keys, etc.).
Answer Call 610: Detects a call ringing at an endpoint device and presses the call key that corresponds to the incoming call.
Dial Feature Code 612: Dials the specified feature code.
Pause Action 614: Pauses for a random duration having a length in-between the specified times.
Release Call 616: Releases a call by pressing the speaker button.
Display Failure Check 618: Monitors the display for a specific output. If the output is detected, testing engine 110 logs the output and marks the script as failed.
Wait for Display 620: Waits the specified amount of time for a display to be detected. If the display is detected testing engine 110 proceeds with the remaining script. If it is not, then testing engine 110 logs a failure and then proceeds with the remaining script.
Display Checks (General): Two exemplary display checks are shown in FIG. 6. One is an exact text matching, 622 (specified per line), and the other takes the display from all lines, strips white space from the beginning and ends of each display line, and concatenates it into one string 624. In this embodiment, interface 600 is configured to allow user 105 to simply look for a case insensitive string. User 105 may add variables to the display checks in order to check for usernames by substituting in, for example, “[user(x)]”. The x denotes the index of the specified user (from the phone list), and “rec” instead of a number will simply use the most recently dialed extension found with the random ext function for that endpoint.
Lines Check: In an exemplary embodiment, user 105 may select the box next to each line user 105 wishes to check in a display check.
String Check: For example, the code may be entered as: disp:30$#Connected to [user(1)]
Cancel Display Failure Check 626: If user 105 began a display failure check (e.g., for a specific action such as transfer), user 105 may cancel it after completing the action. This feature may help to prevent an erroneous failure of the script.
Verify Audio Path 628: Interface 600 may further be configured to determine, using “verify audio path” 628, where the current audio packets are being sent in order to verify a proper connection and protocol to an endpoint device. User 105 may specify the index, IP address or use “rec”, which may use the IP of the most recently dialed random extension.
CLI Command 630: This feature is configured to issue a CLI command to control server 115 specified in the application's options. User 105 may further use “[tenant]” to retrieve the name of the tenant from the application's options as well. This allows the user to make configuration/setting changes to the PBX/Control Server at run-time.

Practitioners will appreciate that the above list of available action set actions is presented for the purpose of explanation only. Any number of additional actions may be included without departing from the scope of the invention. Moreover, the input that may be provided and the function of those actions may be configured as appropriate for particular results.

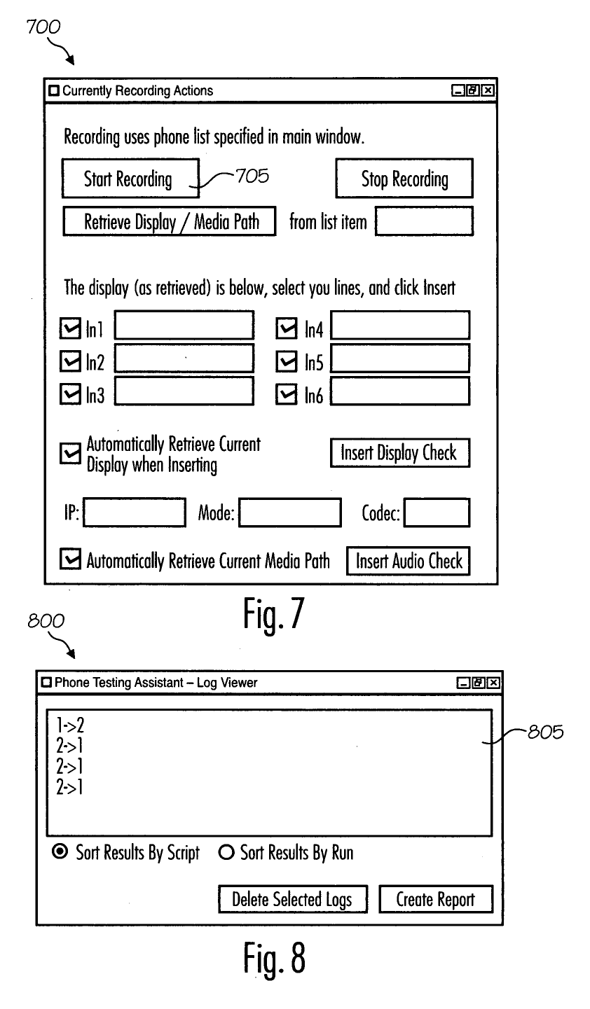

FIGS. 3 and 4 illustrate exemplary steps for performing automated script creation according to an embodiment of the invention. In accordance with other embodiments, however, user 105 may alternatively manually construct action sets by recording action sets. User 105 may select a valid endpoint list 305, followed by the selection of a “record” button 430 within the primary interface 400. In response, testing engine 110 may produce an interface such as depicted in FIG. 7. To begin recording an action set, user 105 may select a “start recording” button 705. When testing engine 110 begins the recording process, user 105 may elect to place calls and insert display checks and audio path checks during the execution of scenarios. A recording module automatically detects whether an endpoint device will be receiving calls or invoking calls, configures the action accordingly, and records all the actions against each endpoint. The following example outlines steps that may be executed at an endpoint device as well as an example of the resulting script for each action.
1. Click Start Recording
2. Wait 5 seconds and then place a call from endpoint A to endpoint B
3. Wait 9 seconds and then answer the call at endpoint B
4. Insert a display check on endpoint A
5. Insert an audio path check on endpoint A
6. Endpoint B presses IK (infinity key) and then 36 (call hold)
7. Insert a display check on endpoint A
8. Endpoint B retrieves call (presses IK 36)
9. Insert a display check on endpoint A
10. Endpoint B releases the call

The entire script created by these ten steps is shown below. Note that there are two action sets; one for endpoint A (or extension 1 on the index list) and one for endpoint B (extension 2).
Ext:1-1;org;1;p:4835;rnd:2-2;p:1000;disp:10$#1—IC TO [user(3)]$#3—XFR CNF$#4—HOLD PARK$#5—MUTE HOTRULES$#6—END CALL;audio:2,TXRX,G711;p:1000;disp:12$#1—HOLDING FOR $#3-$#4-$#5-$#6—END CALL;p:1000;disp:9$#1—IC TO [user(3)]$#3—XFR CNF$#4—HOLD PARK$#5—MUTE HOTRULES$#6—END CALL Ext:2-2;rec;1;p:9125;AnsNow;p:7531;s:IK,3,6;p:6516;s:IK,3,6;p:5438;s:SP

To better explain the actions of the testing engine 110, each step is explained by the following:
Step 1: Initiates a monitoring connection to all endpoints on the specified endpoint list and starts a timer for each endpoint.
Step 2: Endpoint A gets set to originate calls, and the pause time is inserted prior to the digits dialed, and is subsequently reset to 0. All delays less then 600 ms when dialing digits are ignored, and if the module detects that user 105 dials the extension of another endpoint on the endpoint list, the variable for that endpoint replaces the raw dialing string (rnd:2-2 will dial the second endpoint on the phone list). Endpoint B detects that it has an incoming call and resets its timer to 0.
Step 3: Endpoint B recognizes an answer call event so it checks its timer, inserts the appropriate pause (delay from seeing call offered to time it was answered), and then inserts an AnsNow.
Step 4: The timer is recorded and reset, and used for the pause time for the display check against endpoint A. The module also automatically detects usernames and substitutes in the appropriate variables as part of the display check.
Step 5: An audio check is immediately inserted after the last event, and the IP address of endpoint B is automatically detected as being index 2 and substituted in appropriately.
Step 6: Timer is reset for Endpoint B, Pause is inserted, and the raw button presses for entering the feature code are inserted.
Step 7: Display check is inserted on endpoint A in the same manner as step 4.
Step 8: Timer is reset for endpoint B, Pause is inserted, and the raw button presses for entering the feature code are also inserted.
Step 9: Display check is inserted on endpoint A in the same manner as step 4.
Step 10: Timer is recorded and reset, and the release call (SP) button is pressed.

Any aspect of another endpoint device, (e.g., an extension, username, or IP address within the variables for each endpoint device) may be automatically substituted into the script by testing engine 110. This enables the script to be seamlessly played back on any other system since no endpoint information is hard coded. If an endpoint device is monitored but no actions are detected, testing engine 110 may be configured to not create an action set for that endpoint. The recording process automatically inserts the recorded action sets into the open script and user 105 may return to sufficiently edit the scripts manually.

With reference to FIG. 3, an option may be presented to user 105 to turn down the speaker volume prior to executing a script 340. This may be particularly desirable when, for example, the endpoints under test are in close proximity to each other in order to avoid feedback, which may negatively affect a test. After appropriate selection of this feature user 105 may select the desired test scripts 330, and select a “start selected scripts” button 345. Practitioners will appreciate that standard “Windows” type functions may be employed to enable user 105 to select multiple test scripts 330 by, for example, dragging a mouse across the desired items while depressing the left mouse button, depressing the “ctrl” key and selecting the desired test scripts 330, and/or the like.

Primary interface 300 may be further configured to provide additional information related to the progress of the script execution. To begin the disclosed endpoint device testing, user 105 may select a “start” button, such as “Start Selected Scripts” button 345 from the primary interface 300. If more than one script is selected to be run, testing engine 110 may prompt user 105 to enter a unique identifier for the script suite. Reference to the test suite is later made available to user 105 within a log detailing the sequence and results for testing sequences executed.

According to one embodiment, a number of test scripts are run concurrently. In this manner, testing a large number of devices under a large number of scenarios may be accomplished in a relatively short amount of time. However, due to possibility of overlap among two or more scripts, testing engine 110 may execute each script sequentially, in that when a first script completes execution, a next script in a list is invoked. However, if a script has an endpoint executing an infinite action (e.g., looping with the number zero entered for the number of execution times), then the next script may never begin because that endpoint may not finish execution. In that instance, the user may manually click the stop button 350 to cease execution.

User 105 may analyze details of a currently active script by selecting a “details” button 355 from the primary interface 300. An overview of a currently running script may enable user 105 to view, for example, how many times an action set has been executed and whether or not a failure was detected in the currently executing script.

In accordance with further exemplary embodiments of the present invention, system 100 is configured to log the results of any testing performed by the system. In one exemplary embodiment, testing engine 110 is configured to perform real time logging by recording and showing summary results for the currently active (executing) script set. In another exemplary embodiment, and with reference to FIG. 8, testing engine 110 is configured to provide a log viewer interface 800 that is configured to facilitate a user 105 in creating reports and managing logs.

Log viewer interface 800 may, for example, comprise a “details” display portion 805. Details display portion 805, in one exemplary embodiment, displays a running tab of failures, and number of executions for each action. Details display portion 805 may display any suitable information of any level of detail. In another embodiment, more detailed information, such as what may be useful for troubleshooting the system may be provided by selecting a button to create a report.

Log viewer interface 800 may be further configured to facilitate a user creating reports and managing logs for any script or suite that has been executed. Log viewer interface 800 may be invoked by selecting a button from the primary interface 300 as part of the edit menu pull-down list (not illustrated). In one embodiment, a first report type may sort testing results according to test script. In this instance a report is created based on user 105 selection of a specific test script including all instances where the selected script is found in the logs. A second report type is based on user 105 selection of a test suite, which causes testing engine 110 to organize a report based upon the results of a selected run (or test suite). Other report types and/or methods of organizing the results of the test scripts may also be used.

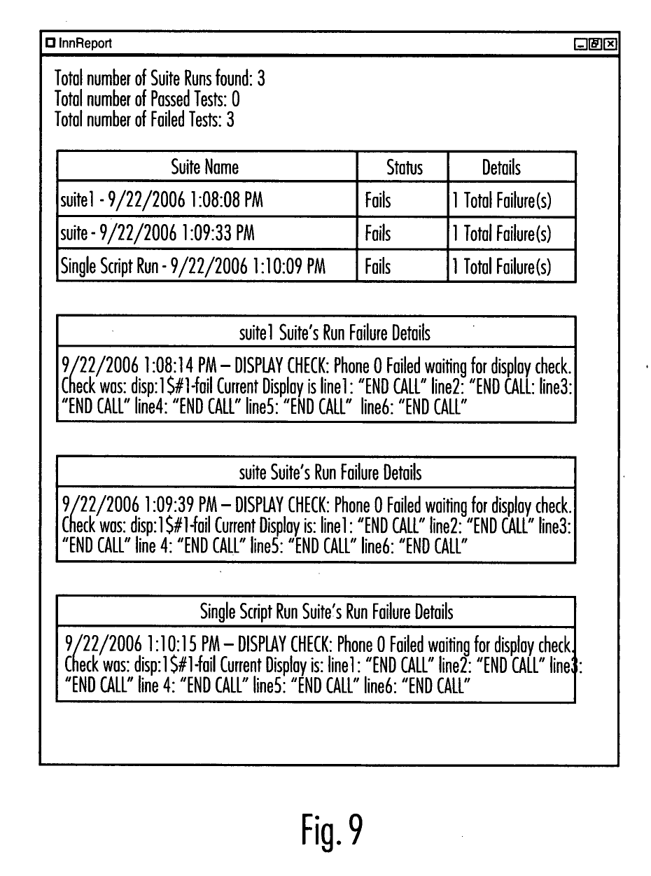

In accordance with another exemplary embodiment, testing engine 110 is configured to generate reports. These reports may include any relevant information and be presented using any organization and/or formatting. In one exemplary embodiment, and with reference to FIG. 9, a report 900 may be divided into three regions. A first region 905 provides a summary of number of passes, number of fails, and total number of results according to a selected script or script suite. A second region 915 provides details relating to each script result found, rather than particular instances of “pass” or “fail.” A third section 920 organizes all failures and provides details for each. As such, user 105 may conveniently see the specific reason why a script has failed. In one embodiment, reports may formatted as HyperText Markup Language (HTML) document, enabling user 105 to save the report for later use or publication. Practitioners will appreciate that testing reports may be configured in any number of ways and include any level of detail. Nevertheless, any reports generated may be saved, at any suitable level of detail, using any suitable method and may be saved in any suitable language/format.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The various system components discussed herein may include one or more of the following: a server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, a computer may include an operating system (e.g., Windows NT, 95/98/2000, OS2, UNIX, Linux, Solaris, MVS, MacOS, etc.) as well as various conventional support software and drivers typically associated with computers. In an exemplary embodiment, communication between components may be through a network or the Internet through a commercially-available web-browser software package.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (1002), the contents of which are hereby incorporated by reference.

The various system components may be independently, separately or collectively suitably coupled to the network via data links which include, for example, a connection to an Internet Provider (ISP) over the local loop as is typically used in connection with standard modem communication, cable modem, Dish networks, ISDN, Digital Subscriber Line (DSL), or various wireless communication methods. See, e.g., GILBERT HELD, UNDERSTANDING DATA COMMUNICATIONS (1996), hereby incorporated by reference. It is noted that the network may be implemented as other types of networks, such as an interactive television (ITV) network.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

The computers discussed herein may provide a suitable website or other Internet-based graphical user interface which is accessible by users, hosts or operators of the system. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

According to one embodiment, testing engine 110 related communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. In relation to interacting with voice applications, the invention contemplates other types of markup language documents including, for example, VXML, CCXML, and SALT. A server may include a web service which receives a request from a web server, the request including a URL (e.g., http://yahoo.com/stockquotes/ge) and an IP address (e.g., 123.56.789). The web server retrieves the appropriate web pages and sends the data or applications for the web pages to the IP address. Web services are applications which are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (1003), hereby incorporated herein by reference.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like.

Each user 105 may be equipped with a computing device, an endpoint device, or a combination of such devices, in order to interact with system 100 and facilitate script creating, running, and/or reporting. User 105 may have a computing unit in the form of a personal computer, although other types of computing units may be used including laptops, notebooks, hand held computers, set-top boxes, cellular telephones, touch-tone telephones and the like.

The invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a device configured to implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and/or program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

It should be understood that the detailed description and specific examples, indicating exemplary embodiments of the present invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above.

We claim:

1. A method for facilitating testing of a plurality of distributed endpoints in a telecommunications system, the method comprising the steps of:
identifying, with unique extension identifiers, the extensions of the distributed endpoints that are to be tested;
creating a script, wherein said script includes at least some of said unique extension identifiers, wherein said script is created at least in part by recording actions taken on one or more of the endpoints, wherein each action taken generates a portion of said script;
automatically converting specific portions of said script into variables, wherein said specific portions comprise at least one of: a specific extension, an IP address, and a username;
saving said script;
executing said script; and
reporting the results of running said script.

2. The method of claim 1, wherein said identifying further comprises automatically detecting all or a subset of the extensions associated with the telecommunications system.

3. The method of claim 1, wherein said identifying further comprises manually entering at least some of said unique extension identifiers; and wherein said method further includes editing a saved script and saving the edited script.

4. The method of claim 1, wherein said identifying comprises using a discover function to list all eligible endpoints in the system.

5. The method of claim 1, wherein executing said script further comprises the steps of:
checking a first script for validity and then parsing it;
starting a master management thread that manages all of the endpoint threads and script execution/assignment, that logs the results for each endpoint, that instantiates all subsequent phone objects, and keeps track of the completion status of the same; and
notifying the management thread of the completion of all assigned actions at one endpoint, and
starting a subsequent script once the management thread has been notified that all the designated endpoints are complete.

6. The method of claim 1, wherein executing said script further comprises executing a group of scripts.

7. The method of claim 1, wherein executing said script further comprises evaluating and executing a first script, and upon completion of execution of said first script, executing a subsequent script.

8. The method of claim 6, wherein executing said script further comprises the steps of: selecting scripts of interest, initiating the test, running a first script, subsequently running a second script, capturing the results of running said first and second scripts, and logging said results for review.

9. The method of claim 1, further comprising the step of obtaining values for said variables, and wherein executing said script further comprises the steps of running said script on designated endpoint devices such that the endpoint devices execute the functions as if a user had pushed a button on the endpoint.

10. A phone testing engine configured for testing a plurality of distributed endpoints in a telecommunications system, the phone testing engine comprising:
a script creating module;
wherein said script creating module is configured to create a script based at least in part on recordation of actions taken on an endpoint device of said system,
wherein said script creating module is further configured to save said script,
wherein said script creating module is further configured to identify specific portions of said script and to substitute variables for said specific portions of said script, such that said script can be played back on a different system seamlessly; and
a script playing module; wherein said script playing module is configured to play the script on designated endpoints of said system.

11. The phone testing assistant of claim 10, wherein said script comprises “checks”; namely: audio path checks and display checks.

12. The phone testing assistant of claim 10, wherein said script comprises at least one of: an action set(s), a script name, a script description, and an endpoint list identifying endpoints that apply to that script; wherein said action set comprises is a series of actions that a specified endpoint is to execute a specified number of times; and wherein said action set is configured such that one action set is associated with each unique action path the endpoints are to perform.

13. The phone testing assistant of claim 12, wherein said action set comprises a series of instructions that virtually emulate at least one action that may be taken on an endpoint device.

14. The phone testing assistant of claim 10, wherein said script creating module is further configured to open a saved script, edit a saved script, and save the edited script.

15. The phone testing assistant of claim 10, wherein said script creating module is further configured to create a script set, wherein said script set comprises a plurality of scripts selected from a list of available scripts; wherein said script set is configured to perform a certain test.

16. The phone testing assistant of claim 10, further comprising a graphical user interface configured to present said script set graphically.

17. The phone testing assistant of claim 10, further comprising a graphical user interface configured to set up test scripts to be run on the endpoints and a control server, designate which endpoints will take part in the test, and directly control the endpoints to appear in the main test control scripts as function calls from the main test scripting software.

18. The phone testing assistant of claim 10, wherein said script creating module is further configured to create an endpoint list comprising a list of extensions that a given script will utilize in its test, wherein said endpoint list further comprises for each endpoint the following unique information: IP address, extension, username.

19. The phone testing assistant of claim 10, wherein said testing device is configured to test the hardware and software of said telecommunications system completely with the exception of actually testing pressing the buttons on the endpoint devices.

20. A method of testing a telecommunications system, wherein the system comprises a plurality of endpoint devices in communication with a Public Branch Exchange, the method comprising the steps of:
generating test scripts, wherein said test scripts comprise instructions that an endpoint device, of said plurality of endpoint devices, can execute, and wherein execution of one of said test script causes said endpoint device to behave in the manner it would have behaved if a user had manually pressed buttons on said endpoint device equivalent to those instructions; and
executing said test scripts on selected endpoints of said plurality of said endpoint
